(19) United States
(12) Patent Application Publication
(10) Pub. No.: US 2016/0275549 A1
(43) Pub. Date: Sep. 22, 2016

(54) INFORMATION PROCESSING APPARATUS, INFORMATION PROCESSING PROGRAM, AND INFORMATION PROCESSING METHOD

(71) Applicant: YAHOO JAPAN CORPORATION, Tokyo (JP)

(72) Inventors: Takeshi AMANO, Tokyo (JP); Yasunori NISHIMOTO, Kanagawa (JP); Yusuke TANAKA, Tokyo (JP)

(73) Assignee: YAHOO JAPAN CORPORATION, Tokyo (JP)

(21) Appl. No.: 15/042,991

(22) Filed: Feb. 12, 2016

(30) Foreign Application Priority Data
Mar. 20, 2015 (JP) 2015-058471

(51) Int. Cl. G06Q 30/02; G06N 7/00

(52) U.S. Cl. CPC G06Q 30/0246; G06N 7/005

(57) ABSTRACT

An information processing apparatus according to an embodiment includes an acquisition unit and a prediction unit. The acquisition unit acquires user information including a number of distributions of an advertisement content to a user targeted for advertisement distribution. The prediction unit predicts an advertising effect of the advertisement content when the advertisement content is distributed to the user, based upon the user information acquired by the acquisition unit.

### CROSS-REFERENCE TO RELATED APPLICATION(S)

The present application claims priority to and incorporates by reference the entire contents of Japanese Patent Application No. 2015-058471 filed in Japan on Mar. 20, 2015.

### BACKGROUND OF THE INVENTION

1. Field of the Invention

The present invention relates to an information processing apparatus, an information processing program, and an information processing method.

2. Description of the Related Art

For the recent years, advertisement distribution via the Internet has been prosperous in association with the boosting popularization of the Internet. For example, the advertisement distribution is popular where advertisement frames designated in advertising media (e.g., web pages) display advertisement contents of corporations, products for sale, and the like, and when people click on the advertisement contents, they are transferred to web pages of advertisers.

In such advertisement distribution, the number of distributions may be determined for each advertisement, and the advertisement may be distributed not to exceed the determined number of distributions. In relation with this, some techniques are known where the frequency defined as the number of advertisement display times per user is averaged in distributing the advertisement (e.g., see Japanese Laid-open Patent Publication No. 2015-18293).

However, although the aforementioned conventional techniques are adapted to distribute the advertisement contents in such a manner as averaging the frequency of distribution to each user, the techniques sometimes fail to enhance the advertising effect because the users targeted for distribution are not necessarily interested in the distributed advertisements.

### SUMMARY OF THE INVENTION

An information processing apparatus according to an embodiment includes an acquisition unit and a prediction unit. The acquisition unit acquires user information including a number of distributions of an advertisement content to a user targeted for advertisement distribution. The prediction unit predicts an advertising effect of the advertisement content when the advertisement content is distributed to the user, based upon the user information acquired by the acquisition unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a relation between CTR and frequency according to an embodiment;

FIG. 2 is a diagram illustrating an example of a configuration of an advertisement distribution system according to the embodiment;

FIG. 3 is a diagram illustrating an example of an information processing apparatus according to the embodiment;

FIG. 4 is a diagram illustrating an example of a user information memory section according to the embodiment;

FIG. 5 is a diagram illustrating an example of an advertisement information memory section according to the embodiment;

FIG. 6 is a flow chart illustrating an example of a model generation process according to the embodiment;

FIG. 7 is a flow chart illustrating an example of a procedure of a predicted value calculation process according to the embodiment; and

FIG. 8 is a hardware configuration diagram illustrating an example of a computer that implements information processing functions according to the embodiment.

### DETAILED DESCRIPTION OF THE PREFERRED EMBODIMENTS

Modes of implementation (referred to as “embodiments” hereinafter) of an information processing apparatus, an information processing program, and an information processing method according to the present application will be described below with reference to the accompanying drawings. Such embodiments are not intended to limit the information processing apparatus, the information processing program, and the information processing method according to the present application.

### 1. Predicted Value Calculation Process

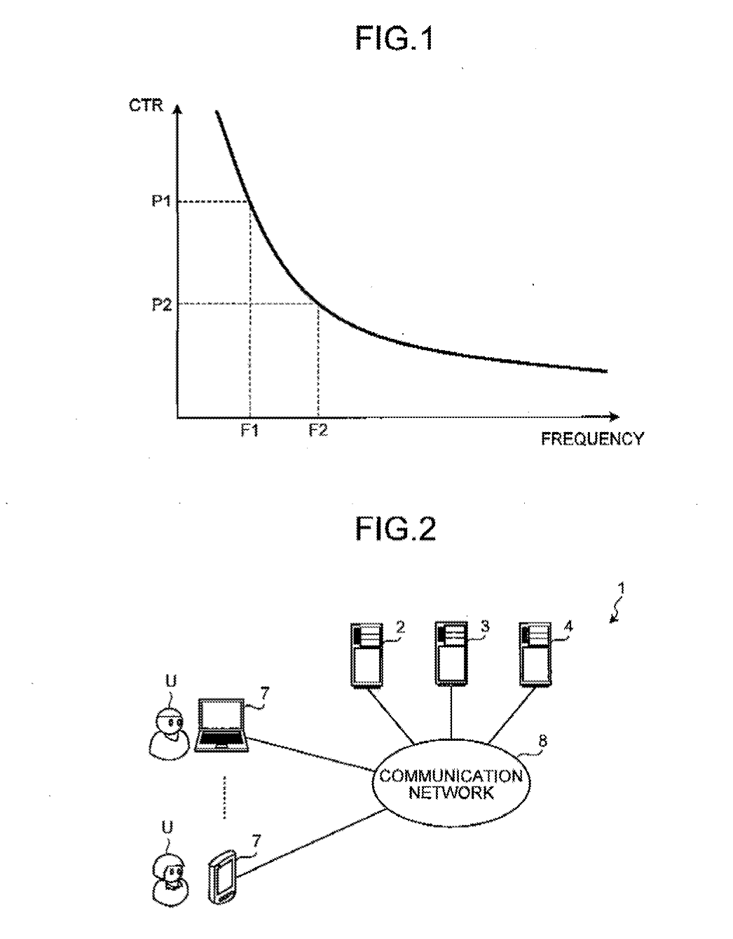

First, a predicted value calculation process according to an embodiment will be described. In the following, an information processing apparatus performs the predicted value calculation process where predicted values of the advertising effect are calculated. Such predicted values of the advertising effect include a CTR (Click through Ratio), a CVR (Conversion Rate), and the like. In the following, a case where the information processing apparatus predicts the CTR as one of predicted values of the advertising effect. FIG. 1 is a diagram illustrating a relation between CTR and the number of distributions (sometimes referred to as “the frequency” hereinafter) of an advertisement content.

First, with reference to FIG. 1, the relation between the CTR and the frequency will be described. In general, as the frequency becomes larger, the CTR becomes smaller. For example, as illustrated in FIG. 1, when the number of distributions of the advertisement content to a user, namely, the frequency is F1, the CTR of the user is P1.

On the other hand, when the frequency of distribution to the user is F2 (F1<F2), the CTR of the user becomes P2 (P1>P2). In this manner, under the circumstances where the same advertisement content is distributed to the same user, the CTR tends to become smaller when the frequency is larger.

The information processing apparatus uses information of the user targeted for advertisement distribution to calculate a predicted value of the CTR. As mentioned above, the CTR of the user targeted for advertisement distribution is varied according to information of the number of distributions of the advertisement content, namely, information of the frequency (referred to as “frequency information”-hereinafter). Thus, the information processing apparatus according to the embodiment acquires user information including the frequency information of the user targeted for advertisement distribution and then predicts the CTR when the advertisement content is distributed to the user, based upon the acquired user information.

The information of the number of distributions of the advertisement content, namely the frequency information includes the number of distributions of the advertisement content distributed, for example, over a predetermined period of time such as the past one month or week. Also, the information processing apparatus calculates the predicted value of the CTR by operating of a prediction model.

The relation between the CTR and the frequency illustrated in FIG. 1 is by way of example. In some case, for example, a function expressing the relation between the CTR and the frequency is graphed in an upside-down U shaped curve where the CTR continues to increase till the number of distributions reaches a specific level and decreases thereafter.

In this manner, the relation between the frequency and the CTR is varied from one user to another targeted for advertisement distribution. Thus, in the predicted value calculation process-according to this embodiment, the information processing apparatus uses, in addition to the predetermined user information, the frequency information to calculate the predicted values of the advertising effect. Hence, the accuracy of predicting the advertising effect can be enhanced.

Discussed below will be an embodiment of an advertisement distribution system that includes the aforementioned information processing apparatus and distributes advertisement contents.

### 2. Advertisement Distribution System

FIG. 2 is a diagram illustrating a configuration example of an advertisement distribution system 1 according to the embodiment. As illustrated in FIG. 2, the advertisement distribution system 1 of this embodiment includes a web server 2, an information processing apparatus 3, an advertisement distribution apparatus 4, and a plurality of terminal apparatuses 7. These apparatuses are connected in communication with one another via a communication network 8. The communication network 8 is the Internet, for example.

In order to clarify the description of the predicted value calculation process by the information processing apparatus 3, the information processing apparatus 3 and the advertisement distribution apparatus 4 are explained as different apparatuses below, and these apparatuses may be implemented in a single unit.

The terminal apparatuses 7 are, for example, PCs (Personal Computers), PDAs (Personal Digital Assistants), tablet terminals, smartphones, and the like that are used by users U. A browser application (referred to as “browser” hereinafter) is installed in such terminal apparatuses 7, for example.

The web server 2 stores a plurality of web pages where advertisement frames are designated. When accessed by the browser in any of the terminal apparatuses 7 via the communication network 8, a control unit of the web server 2 provides a web page corresponding to a URL (Uniform Resource Locator) specified by each of the terminal apparatuses 7.

When the web page is received from the web server 2, the browser in the terminal apparatus 7 sends to the advertisement distribution apparatus 4 an advertisement request for any of the advertisement frames designated in the web page. The advertisement request is a request for distribution of an advertisement content displayed in the advertisement frame, including identification information of the user U (referred to as “user ID” hereinafter) of the terminal apparatus 7 and identification information of the advertisement frame (referred to as “advertisement frame ID” hereinafter), for example. The user ID-includes HTTP (Hypertext Transfer Protocol) cookie, for example.

Accepting the advertisement request from the browser of any of the terminal apparatuses 7, the advertisement distribution apparatus 4 sends to the information processing apparatus 3 a prediction request to predict the advertising effect on the users U of the terminal apparatus 7 targeted for advertisement distribution. The prediction request includes the user ID, an identification information of advertisement contents (referred to as “advertisement IDs” hereinafter), and the like.

Accepting the prediction request, the information processing apparatus 3 calculates, in response to the prediction request, a predicted value eCTR that is a predicted value of the advertising effect of each advertisement contents on the user U and informs the advertisement distribution apparatus 4 of the computation results.

The advertisement distribution apparatus 4 determines the advertisement content to distribute to the terminal apparatus 7, based upon the predicted value eCTR received from the information processing apparatus 3. For example, the advertisement distribution apparatus 4 determines the advertisement content having the largest predicted value eCTR received from the information processing apparatus 3 to be the advertisement content that is to be distributed to the terminal apparatus 7. The advertisement distribution apparatus 4 distributes the advertisement content thus determined to the terminal apparatus 7. The advertisement content is, for example, in a style of a banner advertisement which permits the user U to transfer to a web page of an advertiser when he or she clicks on it.

A configuration example of the information processing apparatus 3 will further be detailed below.

2.1. Information Processing Apparatus 3

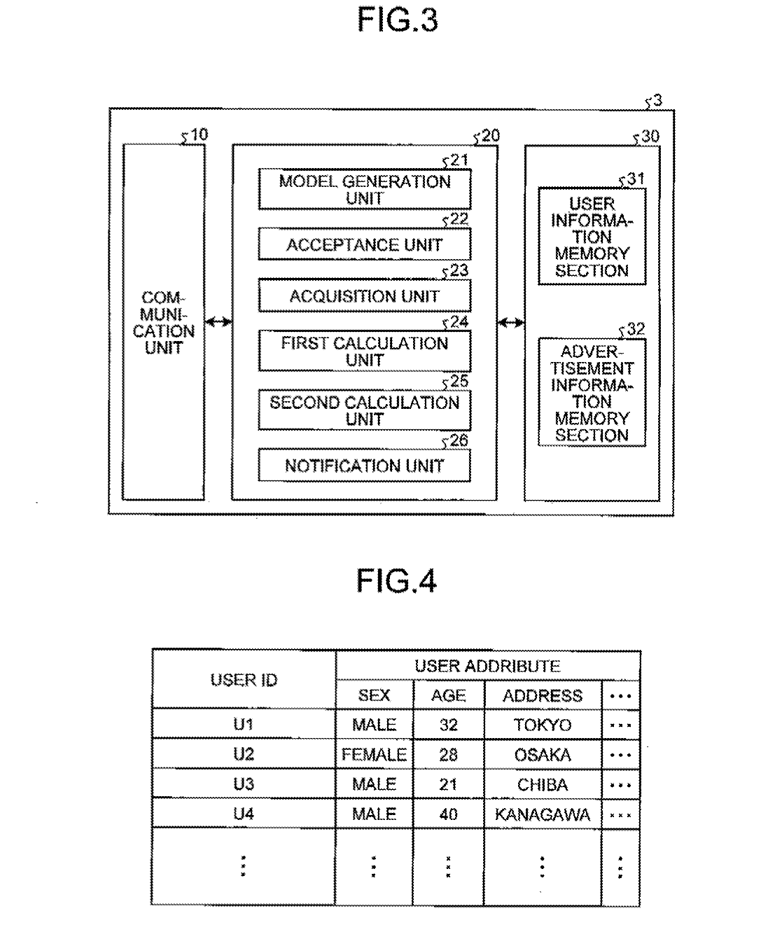

FIG. 3 is a diagram illustrating the configuration example of the information processing apparatus 3. As illustrated in FIG. 3, the information processing apparatus 3 includes a communication unit 10, a controller 20, and a memory 30.

The communication unit 10 is a communication interface that sends and receives information to and from the communication network 8, and is connected to the communication network 8 by wire or wireless communication. The controller 20 is able to send and receive a variety of information to and from the terminal apparatuses 7 and other apparatuses via the communication unit 10 and the communication network 8.

The memory 30 has a user information memory section 31 and an advertisement information memory section 32. The user information memory-section 31 and the advertisement information memory section 32 are, for example, any of a RAM (Random Access Memory), a semiconductor memory device like a flash memory, or a storage device such as a hard disk, an optical disc, and the like.

2.1.1. User Information Memory Section 31

FIG. 4 illustrates an example of the user information memory section 31 according to the embodiment. FIG. 4 is a diagram illustrating an example of the user information memory section 31 according to the embodiment. The user information memory section 31 stores information of attributes of the users U.

In FIG. 4, the user information memory section 31 includes items “User ID,” “User Attribute,” and the like. The “User ID” is identification information that identifies the users U of the terminal apparatuses 7. In FIG. 4, user IDs are described like “U1.” This indicates that one of the terminal apparatuses 7 is identified with a user ID “U1.” In this case, the user Is correspond to reference symbols of the users operating the terminal apparatuses 7.

Further, the “User Attribute” has items “sex,” “age,” “address,” and the like. In this manner, the “User Attribute” is demographic attributes indicating information of population statistics attributes of the users U. User attributes may include “psychographic attributes” indicating-users' preference, values, lifestyle, character, and the like.

2.1.2. Advertisement Information Memory Section 32

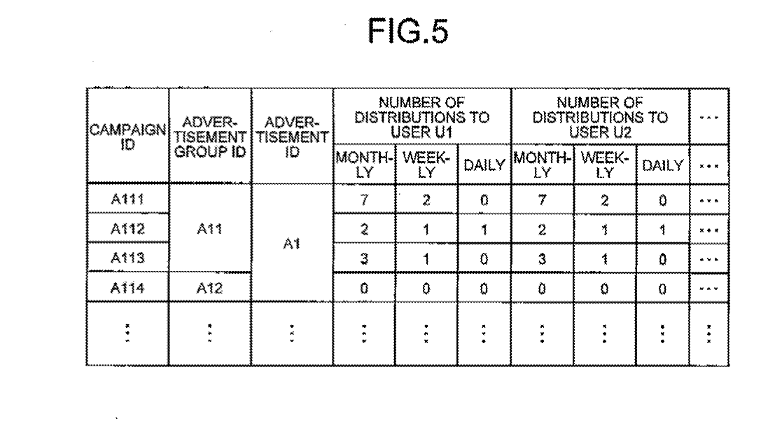

FIG. 5 illustrates an example of the advertisement information memory section 32 according to the embodiment. FIG. 5 is a diagram illustrating an example of the advertisement information memory section 32 according to the embodiment. The advertisement information memory section 32 stores frequency information that is the number of distributions of each advertisement contents to the users U.

In FIG. 5, the “Advertisement ID” is identification information that identifies advertisement contents distributed by the advertisement distribution apparatus 4. Also, a plurality of advertisement contents are named collectively as an advertisement group, and a plurality of advertisement groups are named collectively as a campaign. The “Advertisement Group ID” is identification information that identifies such advertisement groups, and the “campaign ID” is identification information that identifies such campaigns. The advertisement contents distributed by the advertisement distribution apparatus 4 belong to the advertisement groups and campaigns. In this case, advertisement IDs correspond to reference symbols of the advertisement contents distributed by the advertisement distribution apparatus 4.

The advertisement information memory section 32 stores the numbers of distributions of the advertisement contents to the user U in correspondence with the advertisement IDs. Specifically, the advertisement information memory section 32 stores the number of distributions of each advertisement content to the user 0 in the past one month, the number of distributions of the same in the past one week, and the number of distributions of the same in the past one day, respectively.

For example, in FIG. 5, the advertisement distribution apparatus 4 has distributed advertisement content A111 to the user U1 seven times for the past one month and twice for the past one week. For the past one day, the number of distributions of the advertisement content A111 to the user 1 is “0,” which indicates that the advertisement distribution apparatus 4 has not distributed the advertisement content A111 to the user U1.

The information stored in the user information memory section 31 and the advertisement information memory section 32 are updated by the controller 20. The controller 20 can also update, for example, periodically the user attributes and the like stored in the user information memory section 31, based upon histories of web browsing and web searching by the users U and on input information by the users U. Furthermore, the controller 20 can update the user attributes and the like, for example, by periodically acquiring them from an external server.

The controller 20 can, for example, periodically update the number of distributions of the advertisement content stored in the advertisement information memory section 32 for the past one month, based upon a history of distribution of the advertisement content to each of the users U. Also, the controller 20 can update the same, for example, by periodically acquiring the history of distribution of the advertisement content from an external server.

2.1.3. Controller 20

The controller 20 in FIG. 3 is implemented by an integrated circuit such as an ASIC (Application Specific Integrated Circuit), an FPGA (Field Programmable Gate Array), or the like. Internal CPU (Central Processing Unit) or MPU (Micro Processing Unit) executes a program stored in an internal storage device by using a RAM as an operation area and thus the controller 20 functions as a model generation unit 21, an acceptance unit 22, an acquisition unit 23, a first calculation unit 24, a second calculation unit 25, and a notification unit 26. A configuration of the controller 20 is not limited to the aforementioned, but may be replaced with any other configuration if adapted to perform the information processing mentioned later.

The controller 20 uses, a prediction model expressed in the following equation (1) (also referred to as “second prediction model” hereinafter) as a prediction model to calculate a CTR predicted value (also referred to as “predicted value eCTR” hereinafter) based upon the user information including the frequency information.

The CTR expressed in the following equation (2) is a CTR predicted value based upon the user information (also referred to as “first predicted value CTR” hereinafter) and is calculated by carrying out operations of a prediction model expressed in the following equation (3) (also referred to as “first prediction model” hereinafter). In addition, aᵢ and b₁ are coefficients, x_{Freq}_{_}ᵢ is a feature (explanatory variable) regarding the frequency, and x_{CTR}_{_}ᵢ is a feature regarding the predetermined user information.

$$\begin{matrix}eCTR = \frac{y}{1 + y} & ( 1 ) \\ y = exp ( Σ {a}_{i} {x}_{{Freq}_{—} i} + log ( \frac{CTR}{1 - CTR} ) ) & ( 2 ) \\ CTR = \frac{exp ( Σ {b}_{i} {x}_{{CTR}_{—} i} )}{1 + exp ( Σ {b}_{i} {x}_{{CTR}_{—} i} )} & ( 3 )\end{matrix}$$

The prediction model is not limited to those expressed in the above equations (1) to (3), and the predicted value calculation is not limited to the calculation on-such prediction models.

2.1.4. Model Generation Unit 21

The model generation unit 21 generates the first and second prediction models to calculate the CTR predicted value corresponding to each advertisement content based upon the information stored in the user information memory section 31 and the advertisement information memory section 32. The model generation unit 21 may update the first and second prediction models at predetermined cycles (e.g., one cycle per week or one cycle per month). The model generation unit 21 stores the first and second prediction models it has generated, in the memory 30.

A method in which the model generation unit 21 generates the first and second prediction models for the CTR predicted values will be described below.

First Prediction Model

The model generation unit 21 generates the first prediction model for each of the advertisement IDs based upon the information stored in the user information memory section 31. The first prediction model is a prediction model, for example, by logistic regression analysis.

In terms of a logistic regression model expressed in the above equation (3), the model generation unit 21 uses a dependent variable of users Us' having clicked or not on an advertisement content(s) and substitutes the above user information for the feature (explanatory variable) x_{CTR}_{_}ᵢ to obtain the coefficient b_{f} corresponding to the feature x_{CTR}_{_}ᵢ.

The user information, namely, the feature x_{CTR}_{_}ᵢ is, for example, sex, age, or residential area of the users U, advertisement time, browsing web pages, size of the advertisement frames, the number of interested genres, the number of retargeting web sites, the number of keywords for searches, average CTR, average CPC, advertisement distribution frequency, average web-page access time, or the like.

The feature x_{CTR}_{_}ᵢ is, for example, sex, age, address, and the like of the users U. For example, the feature x_{CTR}_{_}₁ is “male,” and it is set to “1” when the users U are male, or otherwise, it is set to “0.” The feature x_{CTR}_{_}₂ is “female,” and it is set to “1” when the users U are female, or otherwise, it is set to “0.” In addition, the feature x_{CTR}_{_}₃ is “sex unidentified,” and it is set to “1” when the users U are of unidentified sex, or otherwise, it is set to “0.” In this manner, the user information is allocated to the feature x_{CTR}_{_}ᵢ.

Also, the dependent variable is set to “1” when the users U click on the advertisement content(s) for the most recent predetermined period (e.g., from five days ago till the present), or otherwise, it is set to “−1.”

The model-generation unit 21 sets the feature x_{CTR}_{_}ᵢ and the dependent variable of each of the users U and obtains the coefficient bᵢ corresponding to the feature x_{CTR}_{_}ᵢ. In this manner, the model generation unit 21 generates the prediction models by logistic regression analysis as the CTR prediction models.

The above-mentioned dependent variable and the feature (explanatory variable) are by way of example, and the model generation unit 21 can generate the CTR prediction models by using other information or part of the aforementioned information. Also, the model generation unit 21 can generate the prediction models, for example, where SVM and the sigmoid fitting are combined.

Second Prediction Model

The model generation unit 21 generates the second prediction model for each of the advertisement IDs based upon the information stored in the advertisement information memory section 32. The second prediction model is a prediction model that is the first prediction model the information of the frequency is added to.

The model generation unit 21 according to the embodiment generates a prediction model considering for a relation between the CTR and the frequency by generating the second prediction model that is the first prediction model the information of the frequency is added to. In other words, the model generation unit 21 generates, in addition to the first prediction model, the prediction model that uses the information of the frequency as the feature (explanatory variable) x_{Freq}_{_}ᵢ, for example, like the prediction model expressed in the equations (1) and (2).

Specifically, when the advertisement information memory section 32 stores the information of the frequency illustrated in FIG. 5, for example, in terms of the prediction model expressed in the following equation (4), the model prediction unit 21 uses the dependent variable of users Us' having clicked or not on the advertisement content(s) and uses the feature (explanatory variable) x_{Freq}_{_}ᵢ of the information of the frequency, and obtains the coefficient aᵢ corresponding to the feature x_{Freq}_{_}ᵢ.

$$y = exp ( log ( \frac{CTR}{1 - CTR} ) + {a}_{i} \cdot {x}_{{m}_{—} ad} + {a}_{2} \cdot {x}_{{m}_{—} adg} + {a}_{3} \cdot {x}_{{m}_{—} comp} + {a}_{4} \cdot {c}_{{w}_{—} ad} + {a}_{5} \cdot {x}_{{w}_{—} adg} + {a}_{6} \cdot {x}_{{w}_{—} comp} + {a}_{7} \cdot {x}_{{d}_{—} ad} + {a}_{8} \cdot {x}_{{d}_{—} adg} + {a}_{9} \cdot {x}_{comp} ) \qquad ( 4 )$$

In this situation, the features xₘ_{_}_{ad}, xₘ_{_}_{adg}, xₘ_{_}_{camp}, x_{w}_{_}_{ad}, x_{w}_{_}_{adg}, x_{w}_{_}_{camp}, x_{d}_{_}_{ad}, x_{d}_{_}_{adg}, and x_{d}_{_}_{camp} in the equation (4) respectively correspond to the feature x_{Freq}_{_}ᵢ in the equation (2). The feature xₘ_{_}_{ad} is the number of distributions of the advertisement content(s) to the users U for the past one month, the feature xₘ_{_}_{adg} is the frequency of distribution of the advertisement group(s) to the users U for the past one month, and the feature xₘ_{_}_{camp} is the number of distributions of the advertisement campaign(s) to the users U for the past one month.

Also, the feature x_{w}_{_}_{ad} is the number of distributions of the advertisement content(s) to the users U for the past one week, the feature x_{w}_{_}_{adg} is the number of distributions of the advertisement group(s) to the users U for the past one week, and the feature x_{w}_{_}_{camp} is the number of distributions of the advertisement campaign(s) to the users U for the past one week. The feature x_{d}_{_}_{ad} is the number of distributions of the advertisement content(s) to the users U for the past one day, the feature x_{d}_{_}_{adg} is the number of distributions of the advertisement group(s) to the users U for the past one day, and the feature x_{d}_{_}_{camp} is the number of distributions of the advertisement campaign(s) to the users U for the past one day.

For example, the number of distributions of the advertisement content A111 to the user U1 for the past one month illustrated in FIG. 5, namely, the feature xₘ_{_}_{ad} is “7.” Also, the number of distributions of an advertisement group A11 where the advertisement content A111 belong, to the user U1 for the past one month, namely, the feature xₘ_{_}_{adg} is “7+2+3=12” that is the total of the numbers of distributions of the advertisement contents A111 to A113 belonging to the group A11.

The number of distributions of an advertisement campaign A1 where the advertisement content A111 belong, to the user U1 for the past one month, namely, xₘ_{_}_{camp} is “7+2+3+0=12” that is the total of the numbers of distributions of the advertisement contents A111 to A114 belonging to the advertisement campaign A1. In this manner, the frequency information regarding the advertisement contents distributed to the user U1 is allocated to each of the futures.

Furthermore, when the user U1 has clicked on the advertisement content A111 for the most recent predetermined period (e.g., from five days ago till the present), for example, the dependent variable is set to “1,” or otherwise, it is set to “−1.” The first predicted value CTR in the equation (4) is calculated by operating the second prediction model using the user information of the user U1 and.

The model generation unit 21 sets the features x_{Freq}_{_}ᵢ of the users U, the dependent variable, and the first predicted value CTR to obtain the coefficient aᵢ corresponding to the features x_{Freq}_{_}ᵢ. In this manner, the model generation unit 21 generates the prediction model by logistic regression analysis as the second prediction model.

The aforementioned dependent variable and the feature (explanatory variable) are by way of example, and the model generation unit 21 can also generate the second prediction model by using other information or part of the aforementioned information. Also, the model generation unit 21 can generate a prediction model, for example, where SVM and the sigmoid fitting are combined. Further, the model generation unit 21 may use, for example, an L1 normalization term when the coefficients for the first and second prediction models are obtained.

2.1.5. Acceptance Unit 22

The acceptance unit 22 accepts the prediction request transmitted from the advertisement distribution apparatus 4. The prediction request accepted by the acceptance unit 22 (referred to as “accepted prediction request” hereinafter) includes the user ID and at least one advertisement ID.

Information of the accepted prediction request (e.g., the user ID and the advertisement ID(s)) is sent to the acquisition unit 23.

In the aforementioned, the example where the acceptance unit 22 accepts the prediction request including the user IDs and the advertisement ID or IDs has been described. The acceptance unit 22 may accept the prediction request including the user IDs. In such a case, the information processing apparatus 3 predicts a second predicted value eCTR for each advertisement content that is probably distributed to the user U corresponding to the user ID.

The advertisement contents probably distributed to the users U refer to advertisement contents that an advertiser wants to distribute to the users U. Specifically, when one advertisement content is dedicated to a predetermined area, for example, the advertiser often wants to distribute it to the users U residing in the predetermined area but not to the users U residing in any area other than the predetermined area.

Under the circumstances, when the addresses of the users U match the predetermined area, the information processing apparatus 3 determines that such an advertisement content is probably distributed to the users U and predicts of the advertising effect of the advertisement contents on the users U. On the contrary, when the addresses of the users U are outside the predetermined area, the information processing apparatus 3 does not predict the advertising effect of the advertisement content on such users U.

The prediction request does not necessarily have to include any advertisement ID, and it may include information that permits identification of the advertisement contents, such as advertisement group ID(s), campaign ID(s), or the like.

2.1.6. Acquisition Unit 23

Acquiring the information of the accepted prediction request from the acceptance unit 22, the acquisition unit 23 acquires from the memory 30 the user information corresponding to such an accepted prediction request.

For example, the acquisition unit 23 acquires from the user information memory section 31 the user attributes corresponding to the user IDs included in the accepted prediction request. Also, the acquisition unit 23 acquires from the advertisement information memory section 32 the user IDs and the frequency information corresponding to the advertisement ID or IDs included in the accepted prediction request. The acquisition unit 23 informs the first calculation unit 24 of the acquired user attributes and informs the second calculation unit 25 of the frequency information.

Also, the acquisition unit 23 acquires from the memory 30 the first and second prediction models corresponding to the advertisement ID or IDs. The acquisition unit 23 informs the first calculation unit 24 of the acquired first prediction model and informs the second calculation unit 25 of the acquired second prediction model.

2.1.7. First Calculation Unit 24

The first calculation unit 24 obtains the first predicted value CTR based upon the information specified by the accepted prediction request. For example, the first calculation unit 24 calculates the first predicted value CTR corresponding to the accepted prediction request, based upon the information of the user attributes acquired by the acquisition unit 23 in response to the accepted prediction request. The first calculation unit 24 informs the second calculation unit 25 of the first predicted value CTR of the calculation result.

Specifically, the first calculation unit 24 uses the information of the user attributes as the feature x_{CTR}_{_}ᵢ and calculates the prediction model expressed in the equation (3). For example, the feature x_{CTR}_{_}₁ is “male,” and when the information of the user attributes include information indicating that the users U are male, the first calculation unit 24 sets the feature x_{CTR}_{_}₁ to “1.” In this manner, attribute information stored as the information of the user attributes in the user information memory section 31 is allocated to the feature x_{CTR}_{_}ᵢ. The first calculation unit 24 calculates the prediction model on the allocated feature x_{CTR}_{_}ᵢ to calculate the first predicted value CTR. The first calculation unit 24 calculates the first predicted value CTR by using the first prediction model corresponding to the advertisement ID or IDs included in the accepted prediction request.

2.1.8. Second Calculation Unit 25

The second-calculation unit 25 obtains the second predicted value eCTR based upon the information specified by the accepted prediction request. For example, the second calculation unit 25 calculates the second predicted value eCTR corresponding to the accepted prediction request, based upon the frequency information acquired by the acquisition unit 23 in response to the accepted prediction request and the first predicted value CTR calculated by the first calculation unit 24. The second calculation unit 25 calculates the second predicted value eCTR by using the second prediction model corresponding to the advertisement ID or IDs included in the accepted prediction request. The second calculation unit 25 informs the notification unit 26 of the second predicted value eCTR of the calculation result.

Specifically, the second calculation unit 25 uses the frequency information as the feature x_{Freq}_{_}ᵢ and calculates the prediction model expressed in the equation (4). For example, the feature xₘ_{_{ad}} is “the number of distributions of an advertisement content(s) to the users U for the past one month,” and when the second predicted value eCTR corresponding to the advertisement content A111 is to be obtained, the first calculation unit 24 sets the feature x_{CTR}_{_}₁ to “7” (see FIG. 5). In this manner, the number of advertisement distributions stored as the frequency information in the advertisement information memory section 32 is allocated to the feature x_{Freq}_{_}ᵢ. The second calculation unit 25 calculates the prediction model based upon the allocated feature x_{Freq}_{_}ᵢ and calculates the second prediction value eCTR.

The first and second calculation units 24 and 25 are prediction units that predict the advertising effect when the advertisement content(s) is distributed to the users U, based upon the user information acquired by the acquisition unit 23 and including the number of distributions of the advertisement content(s) (the information of the frequency). In this manner, the first and second calculation units 24 and 25 calculates of the predicted values of the advertising effect by using the information of the frequency in addition to the predetermined user information, and thereby, the accuracy of predicting the advertising effect can be enhanced.

Although the aforementioned gives the example where the first calculation unit 24 calculates the first predicted value CTR while the second calculation unit 25 calculates the second predicted value eCTR, the model generation unit 21 may be adapted to generate a single prediction model by substituting the first prediction model expressed in the equation (3) for part of the equation (2), and thereby, the calculation of the first predicted value CTR can be omitted. In such a situation, the first calculation unit 24 can also be omitted.

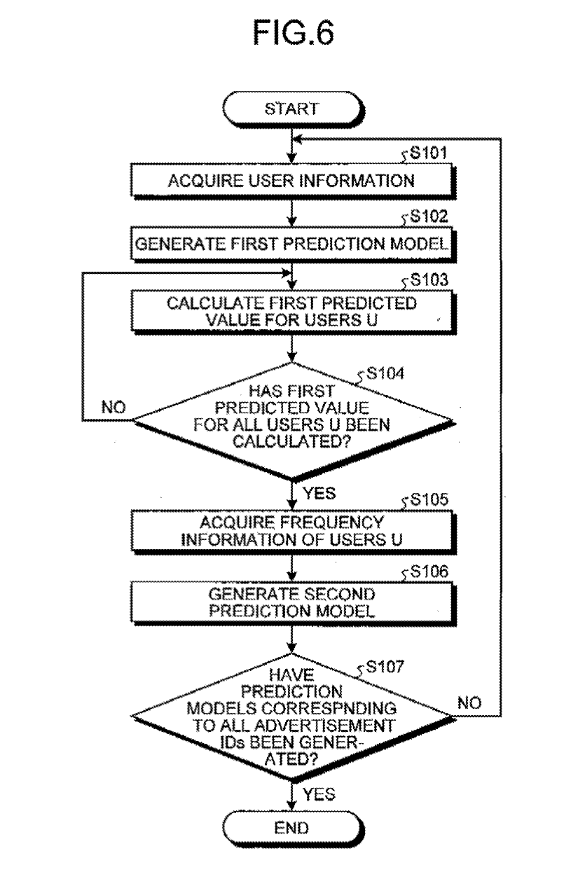

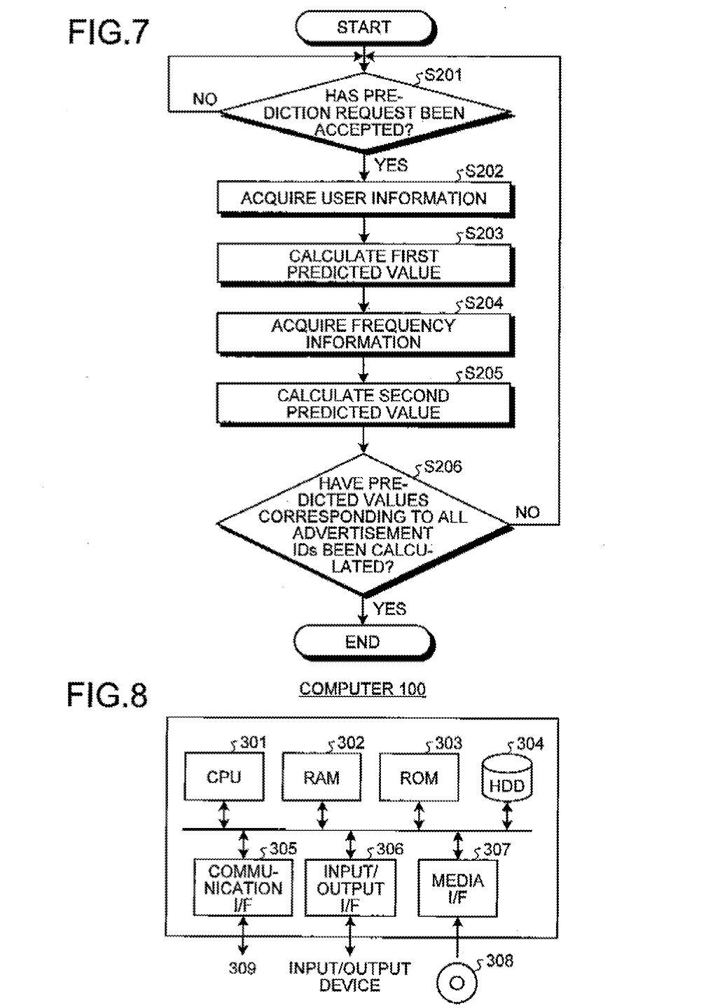

In this manner, when the model generation unit 21 is adapted to generate the single prediction model, the calculation of the first predicted value CTR by using the generated first prediction model is no longer necessary, for example, in a model generation process discussed later and illustrated in FIG. 6, and the calculating process can be reduced. Also, in a predicted value calculation process illustrated in FIG. 7, separate calculations of the first predicted value CTR and the second predicted value eCTR are no longer necessary, and the calculating process can be reduced.

2.1.9. Notification Unit 26

Acquiring the second predicted value eCTR from the second calculation unit, the notification unit 26 notifies the advertisement distribution apparatus 4 of the second predicted value eCTR via the communication unit 10 and the communication network 8, responding to the prediction request.

### 3. Information Processing Procedure

Then, procedures of the model generation process and the predicted value calculation process performed by the information processing apparatus 3 will be described.

3.1. Procedure of Model Generation Process

A procedure of the model generation process performed by the information processing apparatus 3 will be described with reference to FIG. 6. FIG. 6 is a flow chart illustrating an example of the model generation process by the information processing apparatus 3. Such operation is a process executed by the controller 20 of the information processing apparatus 3.

As illustrated in FIG. 6, the information processing apparatus 3 acquires the user information (Step S101). The information processing apparatus 3 generates the first prediction model corresponding to the advertisement ID or IDs, based upon the acquired user information (Step S102).

Next, the information processing apparatus 3 uses the generated first prediction model and calculates the first predicted value CTR for the users U (Step S103). The information processing apparatus 3 determines if the first predicted value CTR for all the users U used to generate the second prediction model has been calculated (Step S104). When the first predicted value CTR for all the users U used to generate the second prediction model has not been calculated (Step S104; No), the information processing apparatus 3 returns to Step S103 and calculates the first predicted value CTR for the remaining users U.

Meanwhile, when the first predicted value CTR for all the users U used to generate the second prediction model has been calculated, (Step S104; Yes), the information processing apparatus 3 acquires the frequency information corresponding to the advertisement ID or IDs (Step S105). The information processing apparatus 3 generates the second prediction model based upon the first predicted value CTR and the frequency information corresponding to the advertisement ID or IDs (Step 3106).

The information processing apparatus 3 determines if the first and second prediction models corresponding to all the advertisement contents, namely, all the advertisement IDs have been generated (Step S107). When the first and second prediction models corresponding to all the advertisement IDs have not been generated (Step S107; No), the information processing apparatus 3 returns to Step S101. Contrarily, when the first and second prediction models corresponding to all the advertisement IDs have been generated (Step S107; Yes), the process is terminated.

The information processing apparatus 3 may substitute the first prediction model expressed in the equation (3) for part of the equation (2) to generate the single prediction model. In such a case, Step S102 to 6104 can be omitted.

3.2. Procedure of Predicted Value Calculation Process

A procedure of the predicted value calculation process by the information processing apparatus 3 will be described with reference to FIG. 7. FIG. 7 is a flow chart illustrating an example of the procedure of the predicted value calculation process by the information processing apparatus 3. Such operation is a process executed by the controller 20 of the information processing apparatus 3.

As illustrated in FIG. 7, the information processing apparatus 3 determined if the prediction request has been accepted (Step S201). When the prediction request has not been accepted (Step S201; No), the information processing apparatus 3 returns to Step S201 and stands ready for accepting the prediction request.

Meanwhile, when the prediction request has been accepted (Step S201; Yes), the information processing apparatus 3 acquires the user information of the users 0 targeted for advertisement distribution based upon the user IDs included in the prediction request (Step S202). The information processing apparatus 3 calculates the first prediction model corresponding to the advertisement ID or IDs included in the prediction request, based upon the acquired user information, and obtains the first predicted value CTR as the calculated result (Step S203).

Succeedingly, the information processing apparatus 3 acquires the information (the frequency information) of the number of distributions of an advertisement content(s) to the users U targeted for advertisement distribution, based upon the user IDs and the advertisement ID(s) included in the prediction request (Step S204). The information processing apparatus 3 calculates the second prediction model corresponding to the advertisement ID or IDs included in the prediction request, based upon the first predicted value CTR obtained in Step 3203 and the frequency information acquired in Step S204, and obtains the second predicted value eCTR as the calculated result (Step S205).

The information processing apparatus 3 determines if the first predicted value CTR and the second predicted value eCTR have been calculated for all the advertisement IDs included in the prediction request (Step S206). When the first predicted value CTR and the second predicted value eCTR have not been calculated for all the advertisement IDs (Step S206; No), the information processing apparatus 3 returns to Step S201. Contrarily, when the first predicted value CTR and the second predicted value eCTR have been calculated for all the advertisement IDs (Step S206; Yes), the process is terminated.

When the information processing apparatus 3 substitutes the first prediction model expressed in the equation (3) for part of the equation (2) to generate the single prediction model, Step S203 can be omitted.

### 4. Other Embodiments

The aforementioned embodiment may be implemented in a wide variety of modes other than its mode as has been described. Other embodiments will be described below.

In the aforementioned embodiment, discussed has been the example where the second calculating unit 25 calculates the second prediction model that is a logistic regression model and obtains the second predicted value eCTR. The second calculation unit 25 can obtain the second predicted value eCTR, for example, by using the frequency information to correct the first predicted value CTR and then obtaining the second predicted value eCTR. Specifically, the second calculation unit 25 multiplies the first predicted value CTR by a coefficient FQ according to the frequency information and obtains the second predicted value eCTR.

eCTR=FQ×CTR (5)

Also, in the aforementioned embodiment, discussed has been the example where the second calculation unit 25 predicts the second predicted value eCTR as the frequency information, based upon the number of distributions of the advertisement content(s) to the users U. Alternatively, the second predicted value eCTR may be predicted based upon the distribution frequency of the advertisement content(s) in addition to the number of distributions of the advertisement content(s), as the frequency information.

Alternatively, the second predicted value eCTR may be predicted based upon the intervals of distributions of the advertisement content(s) as the frequency information, in addition to the number of distributions of the advertisement content(s), or otherwise, the second predicted value eCTR may be predicted based upon both the distribution frequency of the advertisement content(s) and the distribution interval of the advertisement content(s) in addition to the number of distributions of the advertisement content(s).

The distribution frequency of the advertisement content(s) includes the average of the numbers of distributions of the advertisement content(s) over a predetermined period of time, for example. Specifically, the average of the numbers of distributions of the advertisement content(s), for example, counted on a weekly basis over the past one month is calculated, and the resultant average is identified as the distribution frequency of the advertisement content(s). The average as the distribution frequency of the advertisement content(s) is not limited to the average of the frequencies counted on the weekly basis but the average of the frequencies counted on a daily basis. Also, the second calculation unit 25 may use a plurality of distribution frequencies over different periods of time to predict the second predicted value eCTR.

The intervals of distributions of the advertisement content(s) may be of the average of the intervals of distributions of the advertisement content(s) over a predetermined period of time, for example, or otherwise, they may be of the maximal or minimal value. Alternatively, the intervals of distributions may be of an interval elapsing from the latest distribution of the advertisement content(s) till the time when the second predicted value eCTR is predicted.

Identifying the aforementioned distribution frequency and/or the aforementioned distribution interval as the feature of the second prediction model, the second predicted value eCTR can be predicted based upon the distribution frequency and/or the distribution interval.

In the aforementioned embodiment, discussed has been the example where the model generation unit 21 generates the first and second prediction models for each of the advertisement IDs while the first and second calculation units 24 and 25 obtain the first predicted value CTR and the second predicted value eCTR for each of the advertisement IDs. In such a case, the model generation unit 21 may generate the first and second prediction models for each of the advertisement group IDs, and the first and second calculation units 24 and 25 may generate the first predicted value CTR and the second predicted value eCTR for each of the advertisement group IDs. Alternatively, the first and second prediction models may be generated for each of the campaign IDs to generate the first predicted value CTR and the second predicted value eCTR.

In the meantime, among the processes described in the present embodiments, the whole or a part of processes that have been automatically performed can be manually performed. Alternatively, the whole or a part of processes that have been manually performed can be automatically performed in a well-known method. Also, processing procedures, control procedures, concrete titles, and information including various types of data and parameters, which are described in the document and the drawings, can be arbitrarily changed except that they are specially mentioned.

The components of the illustrated apparatuses are what are functionally conceptual and not necessarily have to be physically structured as illustrated in the drawings. In other words, specific modes of dispersion/unification of the apparatuses and units are not limited to those as illustrated, and all or part of them can be structured in an arbitrary unit through functionally or physically dispersing/unifying them.

For example, the memory 30 illustrated in FIG. 3 is not included in the information processing apparatus 3 but in a storage server not illustrated or the like. In such a case, the information processing apparatus 3 acquires information of the users and/or the frequency and the like from the storage server. Also, for example, the information processing apparatus 3 and the advertisement distribution apparatus 4 may be structured in a unified configuration. Furthermore, for example, the information processing apparatus 3 may be dispersed in units of the model generation device with the model generation unit 21 and the model calculation device with the first and second calculation units 24 and 25.

### 5. Hardware Configuration

The information processing apparatus 3 in the aforementioned embodiment is implemented as a computer 100 configured, for example, as illustrated in FIG. 8. FIG. 8 is a hardware configuration diagram illustrating an example of the computer 100 that implements information processing functions according to the embodiment. The computer 100 includes a CPU 301, a RAM 302, a ROM (Read Only Memory) 303, an HDD (Hard Disk Drive) 304, a communication interface (T/F) 305, an input/output interface (I/F) 306, and a media interface (I/F) 307.

The CPU 301 operates based upon programs stored in the ROM 303 or the HDD 304 to control sections. The ROM 303 stores a boot program executed by the CPU 301 upon starting up the computer 100, programs depending on hardware of the computer 100, and the like.

The HDD 304 stores programs executed by the CPU 301, data used by the programs, and the like. The communication interface 305 receives data from other instruments via a communication line 309 to send them to the CPU 301 and sends data generated by the CPU 301 to other instruments via the communication line 309.

The CPU 301 controls output devices such as a display, a printer, and the like, and input devices such as a keyboard, a mouse, and the like via the input/output interface 306. The CPU 301 acquires data from the input devices via the input/output interface 306. Also, the CPU 301 outputs the generated data to the output devices via the input/output interface 306.

A media interface 307 reads programs or data stored in a memory medium 308 and provides them to the CPU 301 via the RAM 302. The CPU 301 loads the RAM 302 with the programs from the memory medium 308 via the media interface 307, and executes the loaded programs. The memory medium 308 is, for example, an optical memory medium such as a DVD (Digital Versatile Disc), a PD (Phase Change Rewritable Disk), or the like, an opto-magnetic memory medium such as an MO (Magneto-Optical disk), a tape medium, a magnetic record medium, a semiconductor memory, or the like.

When the computer 100 functions as the information processing apparatus 3 according to the embodiment, the CPU 301 of the computer 100 executes the programs loaded in the RAM 302 to implement functions of the model generation unit 21, the acceptance unit 22, the acquisition unit 23, the first calculation unit 24, the second calculation unit 25, and the notification unit 26 in the controller 20. The data in the memory 30 are stored in the HDD 304.

The CPU 301 of the computer 100 reads these programs from the memory medium 308 and executes them, or otherwise, it may acquire these programs from some other apparatus via the communication line 309.

### 6. Effect

In this manner, the information processing apparatus 3 according to the embodiment acquires the user information including a number of distributions of an advertisement content to a user targeted for advertisement distribution and predicts an advertising effect of the advertisement content when the advertisement content is distributed to the user, based upon the user information. In this manner, the information processing apparatus 3 can enhance the accuracy of predicting the advertising effect.

The information processing apparatus 3 according to the embodiment predicts the advertising effect of the advertisement content based upon a prediction model including the number of distributions as a feature. In this manner, the information-processing apparatus 3 can obtain the predicted values considering for the number of distributions of the advertisement content in addition to the user information, and thereby the accuracy of predicting the advertising effect can be enhanced.

Also, the information processing apparatus 3 according to the embodiment predicts the advertising effect of the advertisement content based upon the user information excluding the number of distributions and corrects the advertising effect based upon the number of distributions. In this manner, the information processing apparatus 3 can obtain the predicted values considering for the number of distributions of the advertisement content, and thereby, the accuracy of predicting the advertising effect can be enhanced.

The user information in the embodiment includes information of a distribution frequency and/or a distribution interval of the advertisement content to the user targeted for advertisement distribution, and the information processing apparatus 3 predicts the advertising effect of the advertisement content based upon the distribution frequency and/or the distribution interval in addition to the number of distributions. In this manner, the predicted values considering for the information of the distribution frequency and/or distribution interval of the advertisement in addition to the number of distributions of the advertisement can be obtained, and thereby, the accuracy of predicting the advertising effect can be further enhanced.

The “sections, modules, or units” mentioned above may be lexically replaced with “means,” “circuits,” and the like. For example, the communication unit may be lexically replaced with “communication means,” “communication circuit,” or the like.

According to an aspect of the embodiment, it is possible to enhance the accuracy of predicting the advertising effect.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth. What is claimed is:

1. An information processing apparatus comprising:
an acquisition unit that acquires user information including a number of distributions of an advertisement content to a user targeted for advertisement distribution; and
a prediction unit that predicts an advertising effect of the advertisement content when the advertisement content is distributed to the user, based upon the user information acquired by the acquisition unit.

2. The information processing apparatus according to claim 1, wherein the prediction unit predicts the advertising effect of the advertisement content based upon a prediction model including the number of distributions as a feature.

3. The information processing apparatus according to claim 1, wherein the prediction unit predicts the advertising effect of the advertisement content based upon the user information excluding the number of distributions and corrects the advertising effect based upon the number of distributions.

4. The information processing apparatus according to claim 1, wherein
the user information includes information of a distribution frequency and/or a distribution interval of the advertisement content to the user targeted for advertisement distribution, and
the prediction unit predicts the advertising effect of the advertisement content based upon the distribution frequency and/or the distribution interval in addition to the number of distributions.

5. An information processing method comprising:
acquiring user information including a number of distributions of an advertisement content to a user targeted for advertisement distribution; and
predicting an advertising effect of the advertisement content when the advertisement content is distributed to the user, based upon the user information acquired in the acquiring.

6. A non-transitory computer readable storage medium having stored therein an information processing program, the program causing a computer to execute a process comprising:
acquiring user information including a number of distributions, of an advertisement content to a user targeted for advertisement distribution; and
predicting an advertising effect of the advertisement content when the advertisement content is distributed to the user, based upon the user information acquired in the acquiring.
